(19) United States
(12) Patent Application Publication
(10) Pub. No.: US 2011/0120786 A1
(43) Pub. Date: May 26, 2011

(54) Power transmission structure of scooter

(76) Inventor: Yong-Siang Lin, Chia Yi City (TW)

(21) Appl. No.: 12/591,520

(22) Filed: Nov. 23, 2009

(51) Int. Cl. B60K 7/00

(52) U.S. Cl. 180/62

(57) ABSTRACT

This invention relates to a power transmission structure of scooter, in which one rear wheel of the scooter is provided with a power source and the other rear wheel is a free wheel. By the usage of power equipment for driving a single rear wheel, the volume taken by the power equipment is reduced and more space is thus available for accommodation of more power equipments such that both the running distance and running time can be lengthened. As there is no such elongated structure of transmission therein, the power transmission structure has advantages of having sufficient power and power-saving effect so as to achieve cost-saving.

### BACKGROUND OF THE INVENTION

1. Field of the Invention

The present invention relates to a power transmission structure of scooter, more particularly to a power transmission structure enabling to increase running distance and running time of scooter, which is driven by a power source provided on one of rear wheels so as to improve conventional defects happened in prior art.

2. Brief Description of the Prior Art

Usually, power source of a conventional scooter is provided on rear wheel side and a single power source is utilized to drive two rear wheels which in turn move front wheels so as to move the scooter.

An electric scooter disclosed in Taiwanese Patent Gazette No. M269882 comprises a front wheel set and a rear wheel set spaced with each other, a set of frame coupling the front wheel set and the rear wheel set, a stem unit and a control unit provided at front side of the frame, a seat provided at rear side of the frame, and a power unit assembled on the frame to drive a rear axle of the rear wheel set, characterized in that the power unit includes a motor fixed on the frame and electrically connected to the control unit, a reducer mechanism coupled to the motor and is driven by a output shaft of the motor, a transmission shaft driven by the output shaft of the reducer mechanism and enabling to drive the rear axle, and an electronic brake coupled to the motor and electrically connected to the control unit.

During the running of the above scooter, a power source is used to drive two rear wheels, and in turn the front wheels have to be driven by the rear wheels. Hence, driving effect of a single power source is bad and insufficient horsepower phenomena often occur. Furthermore, as both rear wheels have the same the rotation speed, rotational direction of the rear wheels have to be changed by the front wheels. Thus, turning radius of the rear wheels becomes bigger such that rubbing or collision with the neighbor car is possible to happen. Thus, it is unsafe in driving; even it is easy to have traffic accident.

A motor safety device of scooter is disclosed in Taiwanese Patent Gazette No. M267162 in which a motor is provided on the chassis to serve as a power source for starting and driving. The motor is controlled by a clutch rod of an electromagnetic brake mechanism to produce driving power, wherein a location seat is provided on the chassis mounted at a place near the electromagnetic brake mechanism, a limit pull rod being telescopically inserted on the location seat such that it can engage and abut against the edge of the clutch rod of the electromagnetic brake mechanism so as to limit the clutch rod of the electromagnetic brake mechanism.

It is noted from the drawings of the above patent that the motor drives both rear wheels of scooter through the transmission shaft. Hence, the transmission equipment of scooter must have a mechanism which transmits the power to the transmission shaft and both rear wheels coupled to the transmission shaft. This results in defects of bulky volume and high cost. In addition, the motor suffers horsepower loss through power transmission and mechanical loss through the transmission shaft etc . . . . Therefore, there are defects of horsepower insufficiency, strenuous effort in driving or cost-up due to the need of more horsepower in the above patent.

In view of the above shortcomings in prior arts, the inventor of the present invention hereby proposes a power transmission structure of scooter according to further research and improvement conducted on conventional art on the basis of his proficient experience and knowledge in R&D and manufacturing in relevant field, with a purpose to achieve better practical value of the invention.

### SUMMARY OF INVENTION

The main object of the power transmission structure of this invention is to improve the shortcomings of conventional scooter such as bulky volume, high cost and strenuous effort in driving etc. by providing a power source on one of rear wheels to drive scooter.

The above object and advantages of the power transmission structure of scooter of the present invention is realized by the following technique.

A power transmission structure of scooter, in which one of rear wheels of the scooter is provided with a power source and the other rear wheel is a free wheel. By the usage of power equipment for driving a single rear wheel, the volume taken by the power equipment is reduced and more space is thus available for accommodation of more power equipments such that both the running distance and running time can be lengthened. As there is no such elongated structure of transmission therein, the power transmission structure of scooter has the advantages of having sufficient power and power-saving effect so as to achieve cost-saving.

### BRIEF DESCRIPTION OF THE DRAWINGS

FIG. 1 is a schematic view showing the whole outline of the present invention.

FIG. 2 is a perspective schematic view of the present invention seen from another angle.

FIG. 3 is a schematic top view showing the power transmission structure of the present invention.

FIG. 4 is a schematic top view showing another embodiment of the power transmission structure of the present invention.

### DETAILED DESCRIPTION OF PREFERRED EMBODIMENT

The objects, the technical contents and the expected effect of the present invention will become more apparent from the detailed description of the preferred embodiments in conjunction with the accompanying drawings.

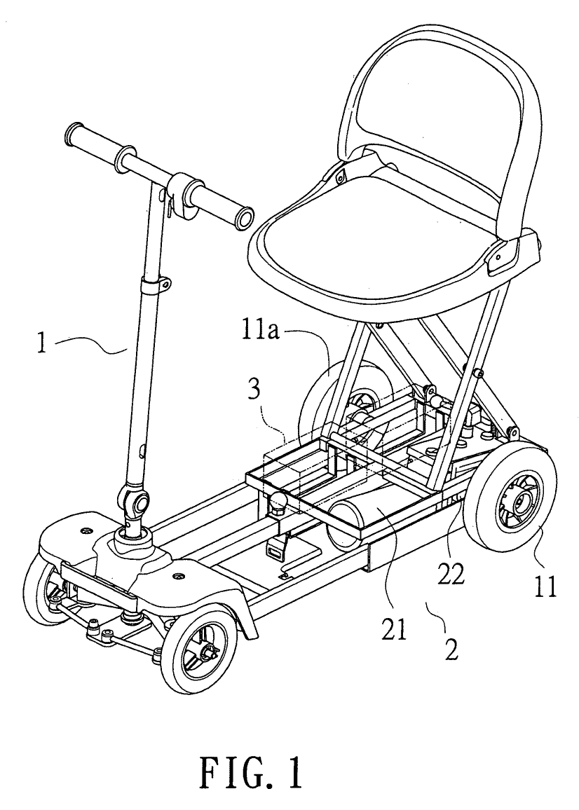

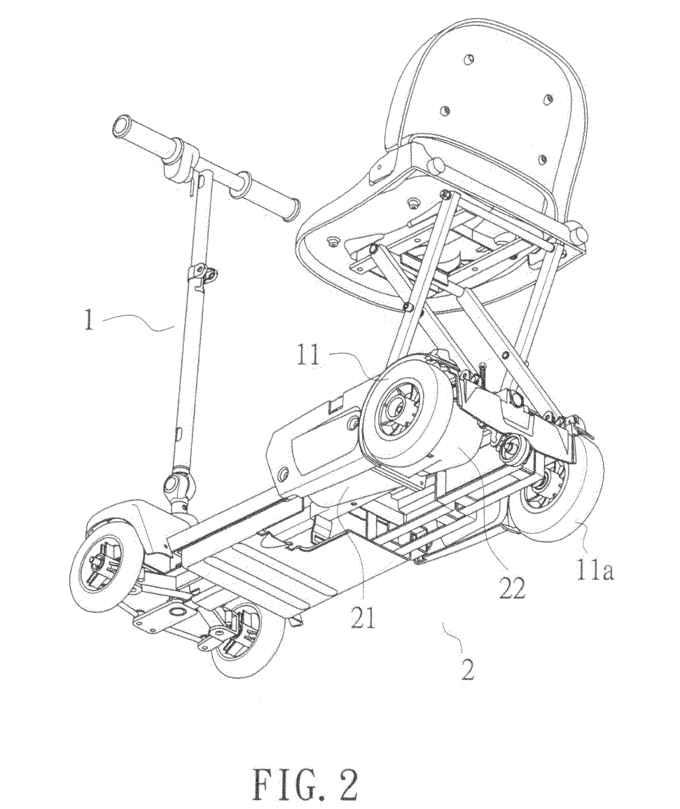

FIGS. 1 to 4 are perspective exploded view, whole outline view of structure, top view and side schematic view respectively showing the power transmission structure of scooter of the present invention, in which scooter (1) is driven by a power mechanism (2), wherein:

one rear wheel (11) of the scooter (1) is provided with a transmission shaft (12) coupled with the power mechanism (2) and the other rear wheel (11a) is a free wheel. In the power mechanism (2), a power source (21) is used to drive a reducer (22) so as, in turn, to drive the scooter (1).

By providing the power mechanism (2) for driving a single rear wheel, the volume taken by the power equipment is reduced and more space is thus available for accommodation of more batteries (3) such that both the running distance and running time of the scooter (1) can be lengthened. As there is no such elongated structure of transmission therein, the power transmission structure has advantages of having sufficient power and power-saving effect so as to achieve cost-saving.

As shown in FIGS. 1 to 3, the power mechanism (2) enabled to drive the scooter (1) is assembled on the transmission shaft (12) of one rear wheel (11), and the other rear wheel (11a) is a free wheel. In the power mechanism (2), a power source (21) (which can be a motor) drives a reducer (22) (which can be a worm reducer or planetary gear reducer) so as to drive the scooter (1). When the rear wheel (11) is driven by the power source (21) to move the scooter (1), the other rear wheel (11a) follows the rear wheel (11) to move freely so that the scooter (1) can move smoothly. Furthermore, as the single wheel driving mode makes the volume taken by the power mechanism (2) become smaller, more space is thus available for accommodation of more than one batteries (3) such that both the running distance and running time of the scooter (1) can be lengthened.

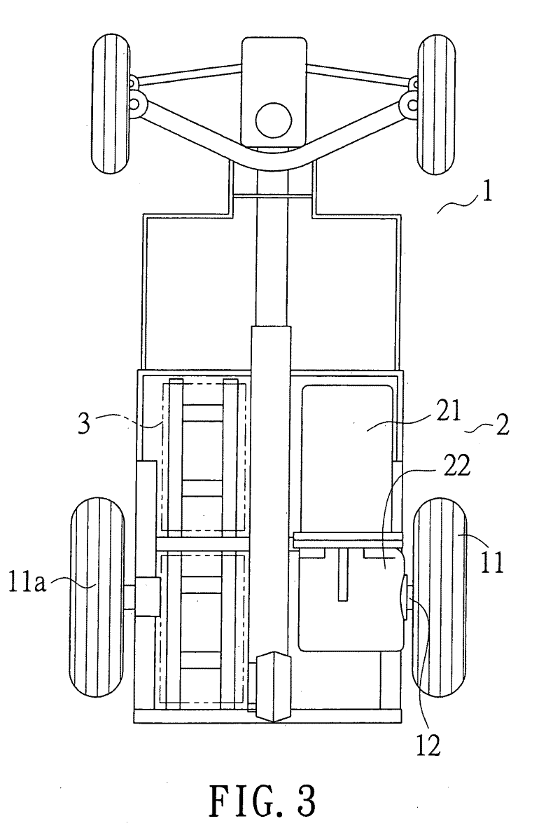

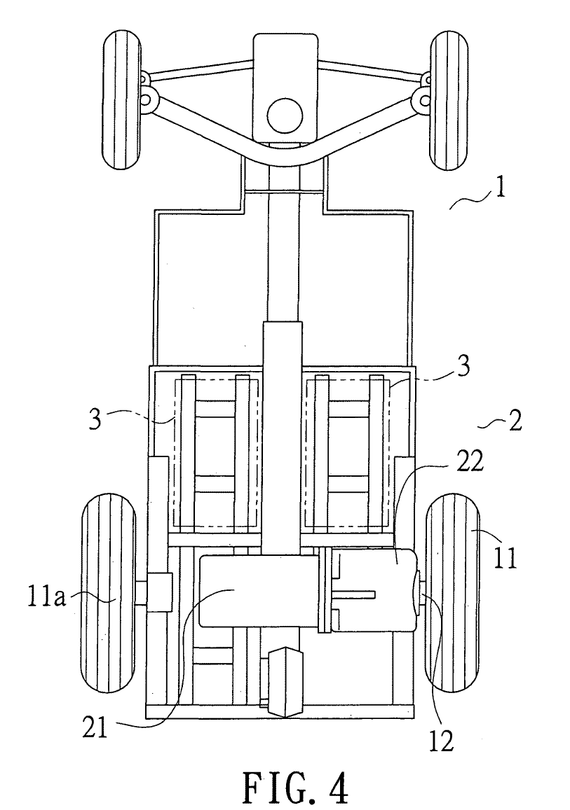

Referring to FIGS. 3 and 4, the power transmission structure of the present invention drives the scooter (1) in single-wheel transmission mode, and the power source (21) is either arranged in vertical transmission arrangement with the reducer (22) as shown in FIG. 3, or in parallel transmission arrangement with the reducer (22) as shown in FIG. 4, such that power from the power source (21) is transmitted to the rear wheel (11).

The abovementioned embodiments or drawings are not intended to restrict the product aspect, structure or usage mode of the present invention. Various modifications and variations can be made without departing from the spirit and scope of the present invention, as set forth in the appended claims.

Based on the foregoing, the power transmission structure of the present invention has the advantages set forth below when comparing with prior art.

1. The power transmission structure of this invention is to improve the shortcomings of conventional scooter such as bulky volume, high cost and strenuous effort in driving of transmission equipment etc. by providing a power mechanism for single-wheel driving on one of rear wheels to drive scooter.

2. The power transmission structure of this invention can reduce the volume taken by the power equipment by utilizing power equipment for driving a single wheel, and hence more space is available for accommodation of more power equipments such that both the running distance and running time can be lengthened.

3. The power transmission structure of this invention utilizes a power transmission mechanism for driving a single wheel, which has no such elongated structure of transmission therein. Hence, the power transmission structure of scooter has the advantages of having sufficient power and power-saving effect to achieve cost saving.

4. The power transmission structure of this invention utilizes a power transmission mechanism for, driving a single wheel. The power source can be either in vertical transmission arrangement or in parallel transmission arrangement with the reducer so as to be adaptable to the design of scooter body.

Summing up above, the embodiment of the present invention can reach anticipated effect, and the specific configurations disclosed herein have yet not found in the prior art of the same category of product, even has not been opened to the public before application.

What is claimed is:

1. A power transmission structure of scooter, in which the scooter is driven by a power mechanism, wherein:
one rear wheel of the scooter is provided with a transmission shaft coupled with the power mechanism and the other rear wheel is a free wheel.

2. The power transmission structure of scooter as claimed in claim 1, wherein a power source in the power mechanism drives a reducer so as, in turn, to drive the scooter.

3. The power transmission structure of scooter as claimed in claim 2, wherein said power source is a motor.

4. The power transmission structure of scooter as claimed in claim 1, wherein the power mechanism on the scooter is provided with electricity by more than one battery.

5. The power transmission structure of scooter as claimed in claim 2, wherein said power source is in vertical transmission arrangement with said reducer.

6. The power transmission structure of scooter as claimed in claim 2, wherein said power source is in parallel transmission arrangement with said reducer.

7. The power transmission structure of scooter as claimed in claim 2, wherein said reducer is a worm reducer.

8. The power transmission structure of scooter as claimed in claim 2, wherein said reducer is a planetary gear reducer.
